(19) United States
(12) Patent Application Publication
(10) Pub. No.: US 2011/0109233 A1
(43) Pub. Date: May 12, 2011

(54) MULTI-CHANNEL CURRENT DRIVER

(75) Inventor: Jia-Shyang Wang, Hsinchu (TW)

(73) Assignee: SILICON TOUCH TECHNOLOGY INC., Hsinchu (TW)

(21) Appl. No.: 12/617,704

(22) Filed: Nov. 12, 2009

(51) Int. Cl. H05B 37/00; G05F 3/02

(52) U.S. Cl. 315/185 R; 327/538; 327/543

(57) ABSTRACT

A multi-channel current driver is provided. One of the channels includes a channel switch and a memory-type current mirror. A first end of the channel switch receives a reference current. A master current end of the memory-type current mirror is coupled to a second end of the channel switch. Wherein, a slave current end of the memory-type current mirror outputs a driving current according to the reference current when the channel switch provides the reference current to the memory-type current mirror, and the slave current end of the memory-type current mirror holds the driving current when the channel switch stops the reference current.

### BACKGROUND OF THE INVENTION

1. Field of the Invention

The invention generally relates to a current driving circuit, and more particularly, to a multi-channel current driver.

2. Description of Related Art

Typically, a multi-channel current driver is used to drive a plurality of current loads, such as multiple light emitting diodes (LEDs). For example, in a large LED display board, a plurality of LEDs are coupled together to form a complete image. The multi-channel current driver has a plurality of channels, and these channels drive the current loads in a one-to-one method. However, when the number of channels increases, a channel-to-channel current skew may become severe.

### SUMMARY OF THE INVENTION

An aspect of the invention provides a multi-channel current driver capable of improving a channel-to-channel current skew and decreasing the quiescent current.

An embodiment of the invention provides a multi-channel current driver including a plurality of channels. One of the channels includes a channel switch and a memory-type current mirror. A first end of the channel switch receives a first reference current. A master current end of the memory-type current mirror is coupled to a second end of the channel switch. When the channel switch provides the first reference current to the memory-type current mirror, a slave current end of the memory-type current mirror correspondingly outputs a driving current. Moreover, when the channel switch ceases to provide the first reference current, the slave current end continues to provide the driving current.

In an embodiment of the invention, the above-described memory-type current mirror includes a first transistor, a sampling capacitor, a sampling switch, and a second transistor. A first end of the first transistor serves as the master current end of the memory-type current mirror, and a first end of the second transistor serves as the slave current end of the memory-type current mirror. The sampling capacitor is coupled to a control end of the first transistor. A first end of the sampling switch is coupled to the first end of the first transistor, and a second end of the sampling switch is coupled to the sampling capacitor. A control end of the second transistor is coupled to the sampling capacitor.

In an embodiment of the invention, the memory-type current mirror includes a first resistor, a sampling switch, a sampling capacitor, an amplifier, a third transistor, and a second resistor. A first end of the first resistor serves as the master current end of the memory-type current mirror, and a first end of the third transistor serves as the slave current end of the memory-type current mirror. A first end of the sampling switch is coupled to the first end of the first resistor. The sampling capacitor is coupled to a second end of the sampling switch. A first input end of the amplifier is coupled to the sampling capacitor. A second end of the third transistor is coupled to a second input end of the amplifier. A control end of the third transistor is coupled to an output end of the amplifier. A first end of the second resistor is coupled to the second end of the third transistor.

In one embodiment of the invention, the multi-channel current driver further includes a current source and a current mirror. The current source provides a second reference current. A master current end of the current mirror is coupled to the current source so as to receive the second reference current, and a slave current end of the current mirror is coupled to the channels so as to provide the first reference current.

In summary, an embodiment of the invention provides a multi-channel current driver adopting a TDM (Time Division Multiplexing) method to provide a reference current to the memory-type current mirrors of each of the channels, thereby improving the channel-to-channel current skew and decreasing the quiescent current.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a function of a multi-channel current driver in accordance with an embodiment of the invention.

FIG. 2 is a schematic block diagram illustrating a function of another multi-channel current driver in accordance with an embodiment of the invention.

FIG. 3 is a timing diagram of a plurality of control signals depicted in FIG. 2 in accordance with an embodiment of the invention.

FIG. 4 is a schematic circuit diagram of the memory-type current memory depicted in FIG. 2 in accordance with an embodiment of the invention.

FIG. 5 is a schematic circuit diagram of the memory-type current memory depicted in FIG. 2 in accordance with an embodiment of the invention.

FIG. 6 is a schematic block diagram illustrating a function of a multi-channel current driver in accordance with another embodiment of the invention.

FIG. 7 is a schematic circuit diagram of a current mirror depicted in FIG. 6 in accordance with an embodiment of the invention.

### DESCRIPTION OF EMBODIMENTS

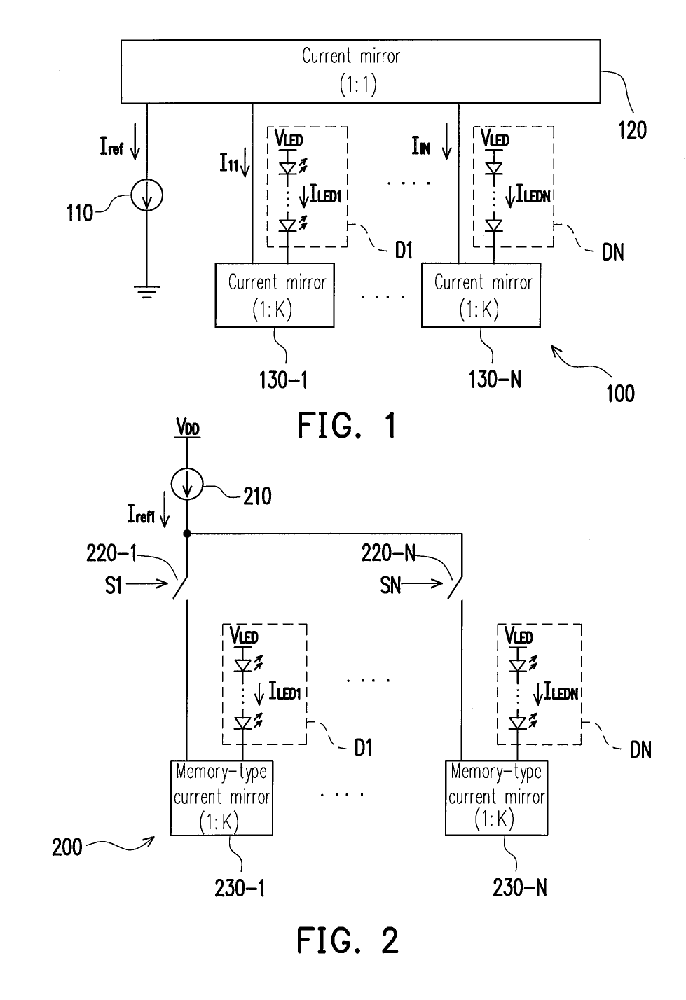

FIG. 1 is a schematic block diagram illustrating a function of a multi-channel current driver 100 in accordance with an embodiment of the invention. The multi-channel current driver 100 is adapted to drive a plurality of current loads. In FIG. 1, an LED string D1 and an LED string DN represent the current loads. The anodes of the LED strings D1 and DN are coupled a voltage source V_{LED}, and the cathodes are coupled to the multi-channel current driver 100. The multi-channel current driver 100 has a plurality of channels, and these channels drive the LED strings D1 and DN in a one-to-one method. Each of the channels respectively has a current mirror (e.g., a current mirror 130-1 or a current mirror 130-N).

Referring to FIG. 1, the multi-channel current driver 100 also has a current source 110 and a current mirror 120. According to a current at a master current end (e.g. a reference current I_{ref} provided by the current source 110), the current mirror 120 respectively provides an equal amount of current I₁₁˜I_{IN} to the current mirrors 130-1˜130-N. According to a current at the master current end (e.g. a reference current I₁₁˜I_{IN} provided by the current mirror 120), the current mirrors 130-1˜130-N of each of the channels respectively provides a K-multiple amount of driving current I_{LED}˜I_{LEDN} to the LED strings D1˜DN.

Ideally, according to the reference current I_{ref}, the current mirror generates equal amounts of current I₁₁˜I_{IN}. However, in practice, due to production drifts or other factors, a slight error may occur. When the number of channels increases, a channel-to-channel current skew may become severe.

Moreover, the driving currents I_{LED1}˜I_{LEDN} have a magnitude of 10 mA. By using current mirrors 130-1˜130-N having a current ratio of 1:K, the current values of the reference currents I_{ref} and I₁₁-I_{IN} can be drastically reduced. In other words, a quiescent current of the multi-channel current driver 100 is lowered. The above-described K can be any real number. However, when the number of channels expands, the quiescent current proportionally increases. For example, if I_{LED1}˜I_{LEDN} is 50 mA, K=50, and the number of channels N is 8, then the quiescent current of the current mirror 120 is I_{ref}+I₁₁+ . . . +I_{IN}=1 mA+1 mA+ . . . +1 mA=9 mA. If the number of channels N is 196, then the quiescent current I_{ref}+I₁₁+ . . . +I_{IN} of the current mirror 120 is 197 mA. Clearly, the quiescent current when the number of channels N is 196 is far larger than the quiescent current when the number of channels N is 8. A large quiescent current increases an operational temperature of the multi-channel current driver 100.

FIG. 2 is a schematic block diagram illustrating a function of a multi-channel current driver 200 in accordance with an embodiment of the invention. The multi-channel current driver 200 includes a current source 210 and a plurality of channels. The current source 210 is coupled to the channels to provide a first reference current I_{ref1}. The channels drive a plurality of current loads according to the first reference current I_{ref1}. In FIG. 2, the LED string D1 and the LED string DN represent the current loads. In the present embodiment of the invention, the implementations of the channels can be identical. A first channel includes a channel switch 220-1 and a memory-type current mirror 230-1, in which the channel switch 220-1 is controlled by a control signal S1. Similarly, an N^{th} channel includes a channel switch 220-N and a memory-type current mirror 230-N, in which the channel switch 220-N is controlled by a control signal SN.

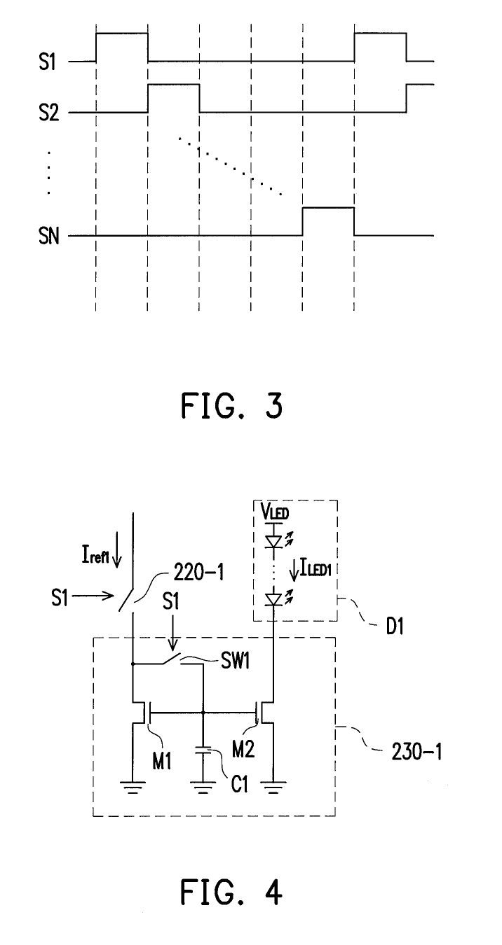

FIG. 3 is a timing diagram of a plurality of control signals depicted in FIG. 2 in accordance with an embodiment of the invention. When the control signal S1 is at a logical high level, other control signals (e.g., S2, SN) are at a logic low level. Therefore, during this period only the channel switch 220-1 of the first channel is turned on. When a control signal S2 is at the logic high level, other control signals (e.g., S1, SN) are at the logic low level. Therefore, during this period only the channel switch (not drawn, please refer to the first channel) of the second channel is turned on.

Accordingly, when the control signal SN is at the logic high level, other control signals (e.g., S1, S2) are at the logic low level. Therefore, during this period only the channel switch (not drawn, please refer to the first channel) of the N^{th} channel is turned on. Consequently, a current source 210 can adopt a TDM (Time Division Multiplexing) method to provide the reference current I_{ref1} to the of memory-type current mirrors 230-1˜230-N of each of the channels, thereby improving the channel-to-channel current skew and decreasing the quiescent current.

The first channel is used in an embodiment for description hereinafter. The description for other channels (e.g., the N^{th} channel) can be referenced to the related description of the first channel. Referring to FIG. 2, in the first channel, a first end of the channel switch 220-1 is coupled to the current source 210 so as to receive the first reference current I_{ref1}. A master current end of the memory-type current mirror 230-1 is coupled to a second end of the channel switch 220-1. When the channel switch 220-1 provides the first reference current I_{ref1} to the memory-type current mirror 230-1 (i.e., the control signal S1 is at the logic high level), a slave current end of the memory-type current mirror 230-1 correspondingly outputs a driving current I_{LED1} to the LED string D1. When the channel switch 220-1 ceases to provide the first reference current I_{ref1} (i.e., the control signal S1 is at the logic low level), the slave current end of the memory-type current mirror 230-1 continues to output the driving current I_{LED1} to the LED string D1.

It should be noted that, the memory-type current mirror 230-1 can record the current value of the first reference current I_{ref1}. Therefore, during the period when the first reference current I_{ref1} is not provided, the memory-type current mirror 230-1 can continually output the driving current I_{LED1} to the LED string D1 based on the previously recorded current value. The present embodiment does not limit the implementation method for the memory-type current mirror 230-1. An user applying the present embodiment can implement the memory-type current mirror 230-1 according to design requirements. For example, the memory-type current mirror 230-1 can be implemented with a charge storage type current mirror.

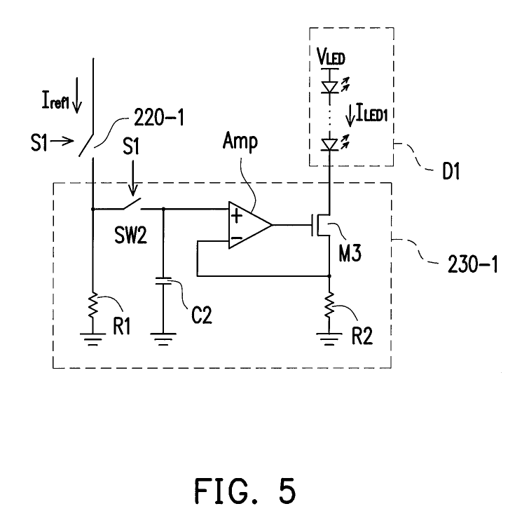

FIG. 4 is a schematic circuit diagram of the memory-type current mirror 230-1 depicted in FIG. 2 in accordance with an embodiment of the invention. Referring to FIG. 4, the memory-type current mirror 230-1 includes a first transistor M1, a second transistor M2, a sampling capacitor C1, and a sampling switch SW1. In the present embodiment of the invention, the first transistor M1 and the second transistor M2 are both NMOS (N-channel metal oxide semiconductor) transistors. A first end of the first transistor M1 (e.g., the drain) serves as the master current end of the memory-type current mirror 230-1, and a first end of the second transistor M2 (e.g., the drain) serves as the slave current end of the memory-type current mirror 230-1.

A first end of the sampling switch SW1 is coupled to the drain of the first transistor M1, and a second end of the sampling switch SW1 is coupled to a first end of the sampling capacitor C1. A second end of the sampling capacitor C1 is coupled to a second voltage (e.g., the ground voltage). A control end (e.g., the gate) of the first transistor M1 is coupled to the first end of the sampling capacitor C1, and the second end (e.g., the source) of the first transistor M1 is coupled to the second voltage (e.g., the ground voltage). A control end (e.g., the gate) of the second transistor M2 is coupled to the first end of the sampling capacitor C1, and the second end (e.g., the source) of the second transistor is coupled to the second voltage (e.g., the ground voltage).

The above-described sampling switch SW1 is controlled by the control signal S1. When the control signal S1 is at the logic high level, the channel switch 220-1 and the sampling switch SW1 are turned on. At this time the first and second transistors M1 and M2 in the memory-type current mirror 230-1 form a normal current mirror mapping the first reference current I_{ref1} as the driving current I_{LED1} at a predetermined multiple rate (e.g., K times). Moreover, when the sampling switch SW1 is turned on, the sampling capacitor C1 concurrently stores a bias voltage of the first and second transistors M1 and M2. When the control signal S1 is at the logic low level, the channel switch 220-1 and the sampling switch SW1 are turned off. At this time, although the master current end of the memory-type current mirror 230-1 no longer have the first reference current I_{ref1}, since the sampling capacitor C1 already stored the bias voltage of the first and second transistors M1 and M2, the slave current end of the memory-type current mirror 230-1 can still continue to output the driving current I_{LED1} to the LED string D1.

The implementation method of the memory-type current mirror 230-1 is not limited to the depiction in FIG. 4. For example, FIG. 5 is a schematic circuit diagram of the memory-type current memory 230-1 depicted in FIG. 2 in accordance with another embodiment of the invention. Referring to FIG. 5, the memory-type current mirror 230-1 includes a first resistor R1, a second resistor R2, a sampling switch SW2, a sampling capacitor C2, an amplifier Amp, and a third transistor M3. A first end of the first resistor serves as the master current end of the memory-type current mirror 230-1, and a first end (e.g., the drain) of the third transistor M3 serves as the slave current end of the memory-type current mirror 230-1. In the present embodiment of the invention, the amplifier Amp is an operational amplifier, whereas the third transistor M3 is an NMOS transistor.

A second end of the first transistor R1 is coupled to the second voltage (e.g., to the ground voltage). A first end of the sampling switch SW2 is coupled to the first end of the first resistor R1. A first end of the sampling capacitor C2 is coupled to a second end of the sampling switch SW2, and a second end of the sampling capacitor C2 is coupled to the second voltage. A first input end of the amplifier Amp is coupled to the first end of the sampling capacitor C2. A second input end of the amplifier Amp and an output end are respectively coupled to a second end (e.g., the source) and a control end (e.g., the gate) of the third transistor M3. A first end of the second resistor R2 is coupled to the source of the third transistor M3, and a second end of the second resistor R2 is coupled to the second voltage. The first input end of the above-described amplifier Amp can be a non-inverting input node, and the second input end of the amplifier Amp can be an inverting input node.

The above-described sampling switch SW2 is controlled by the control signal S1. when the control signal S1 is at the logic high level, the channel switch 220-1 and the sampling switch SW2 are turned on. At this time, the first resistor R1 converts the first reference voltage I_{ref1} into a corresponding voltage. This corresponding voltage is stored in the sampling capacitor C2. The amplifier Amp and the third transistor M3 form a voltage follower. According to the voltage stored in the sampling capacitor C2, the voltage follower correspondingly adjusts a voltage at the first end of the second resistor R2. By using the second resistor R2, the aforementioned voltage at the first end of the second resistor R2 can be converted into the corresponding driving current I_{LED1}. When the control signal S1 is at the logic low level, the channel switch 220-1 and the sampling switch SW1 are turned off. At this time, although the master current end of the memory-type current mirror 230-1 no longer have the first reference current I_{ref1}, since the sampling capacitor C2 already stored the aforementioned voltage, the slave current end of the memory-type current mirror 230-1 can still continuously output the driving current I_{LED1} to the LED string D1.

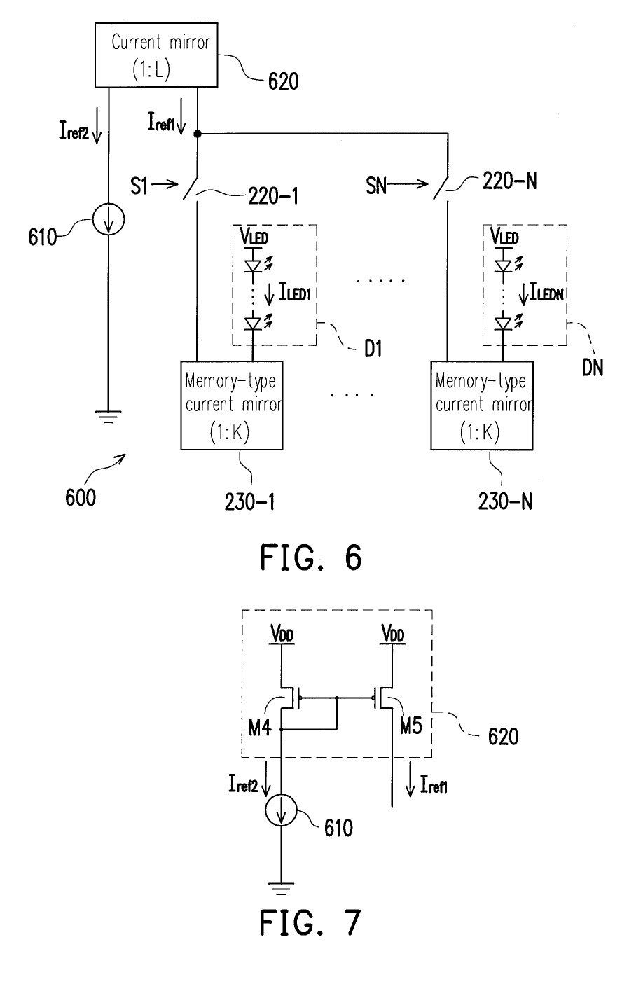

The implementation method of the memory-type current mirror 200 is not limited to the depiction in FIG. 2. For example, FIG. 6 is a schematic block diagram illustrating a function of a multi-channel current driver 600 in accordance with another embodiment of the invention. The multi-channel current driver 600 also has a plurality of channels. The description for the implementation of these channels can be referred to the relevant description of the multi-channel current driver 200, therefore no further mention thereof is provided. The multi-channel current driver 600 differs with the multi-channel current driver 200 in that the multi-channel current driver 600 has a current source 610 and a current mirror 620. The current source 610 provides a second reference current I_{ref2}. A master current end of the current mirror 620 is coupled to the current source 610, and a slave current end of the current mirror 620 is coupled to each of the channels. The current mirror 620 receives the second reference current I_{ref2} provided by the current source 610, and the current mirror 620 maps the second reference current I_{ref2} as the first reference current L_{ref1} at a predetermined multiple rate (e.g., L times), so as to provide the first reference current I_{ref1} to the channel switches 220-1˜220-N of each of the channels. The above-described L can be any real number, for example L=1.

The present embodiment does not limit the implementation method for the current mirror 620. The user applying the present embodiment can implement the current mirror 620 according to the design requirements. For example, FIG. 7 is a schematic circuit diagram illustrating the current mirror 620 depicted in FIG. 6 in accordance with an embodiment of the invention. The current mirror 620 includes a fourth transistor M4 and a fifth transistor M5. A first end (e.g., the drain) of the fourth transistor M4 serves as the master current end of the current mirror 620, and a first end (e.g., the drain) of the fifth transistor M5 serves as the slave current end of the current mirror 620. A second end of the fourth transistor M4 (e.g., the source) is coupled to a first voltage (e.g., a system voltage V_{DD}), and a control end (e.g., the gate) of the fourth transistor M4 is coupled to the drain of the fourth transistor M4. A second end (e.g., the source) of the fifth transistor M5 is coupled to the first voltage, and a control end (e.g., the gate) of the fifth transistor M5 is coupled to the gate of the fourth transistor M4. In the present embodiment of the invention, the above-described fourth transistor M4 and fifth transistor M5 are both PMOS (P-channel metal oxide semiconductor) transistors.

In light of the foregoing, an above-described embodiment adopts the TDM method to transmit the first reference current I_{ref1} to the memory-type current mirrors 230-1˜230-N of each of the channels. When the master current ends of the memory-type current mirrors 230-1˜230-N no longer have the first reference current by employing the memory function of the memory-type current mirrors 230-1˜230-N, the slave current ends of the memory-type current mirrors 230-1˜230-N can still continuously output the driving currents I_{LED1}˜I_{LEDN} to the LED strings D1˜DN. Comparing to FIG. 1 and using an example that assumes again the driving currents I_{LED1}˜I_{LEDN} are 50 mA, K=50, and L=1, if the number of channels N in FIG. 6 is 8, then the quiescent current of the current mirror 620 is I_{ref1}+I_{ref2}=1 mA+1 mA=2 mA. Clearly, the quiescent current (2 mA) of the multi-channel current driver 600 is smaller than the quiescent current (9 mA) of the multi-channel current driver 100. If the number of channels N in FIG. 6 is 196, then the quiescent current of the current mirror 620 is I_{ref1}˜I_{ref2}=1 mA+1 mA=2 mA. Clearly, the quiescent current (2 mA) of the multi-channel current driver 600 is far smaller than the quiescent current (197 mA) of the multi-channel current driver 100. As clearly illustrated by this example, the energy savings of the multi-channel current driver 600 becomes significant as the number of channel increases.

Moreover, in practice when N=196, the channel-to-channel current skew of the multi-channel current driver 100 is severe due to production drifts or other factors. The multi-channel current drivers 200 and 600 depicted in FIG. 6 do not employ the current mirror 120 having single-input multiple-outputs (N). On the other hand, the multi-channel current drivers 200 and 600 adopt the TDM method to transmit the same first reference current I_{ref1} to the memory-type current mirrors 230-1˜230-N of each of the channels. Therefore, whether the number of channels N is 196, 8 or 2, the channel-to-channel current skew is the same and is not susceptible to deterioration. Therefore, the multi-channel current drivers 200 and 600 in the above-described embodiment is particularly suitable for applications demanding uniformity between each of the multiple channels, for example in a large LED display board.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A multi-channel current driver, comprising a plurality of channels, one of the channels comprising:
a channel switch having a first end receiving a first reference current; and
a memory-type current mirror having a master current end coupled to a second end of the channel switch, wherein when the channel switch provides the first reference current to the memory-type current mirror, a slave current end of the memory-type current mirror outputs a driving current, and when the channel switch ceases to provide the first reference current, the slave current end of the memory-type current mirror continues to output the driving current.

2. The multi-channel current driver as claimed in claim 1, wherein the slave current end of the memory-type current mirror is coupled to a light-emitting diode (LED) string.

3. The multi-channel current driver as claimed in claim 1, wherein the memory-type current mirror comprises:
a first transistor having a first end serving as the master current end of the memory-type current mirror;
a sampling capacitor coupled to a control end of the first transistor;
a sampling switch having a first end coupled to the first end of the first transistor, and a second end coupled to the sampling capacitor; and
a second transistor having a first end serving as the slave current end of the memory-type current mirror, and a control end coupled to the sampling capacitor.

4. The multi-channel current driver as claimed in claim 3, wherein the first transistor and the second transistor are N-channel metal oxide semiconductor (NMOS) transistors.

5. The multi-channel current driver as claimed in claim 1, wherein the memory-type current mirror comprises:
a first resistor having a first end serving as the master current end of the memory-type current mirror;
a sampling switch having a first end coupled to the first end of the first resistor;
a sampling capacitor coupled to a second end of the sampling switch;
an amplifier having a first input end coupled to the sampling capacitor;
a third transistor having a first end serving as the slave current end of the memory-type current mirror, a second end coupled to a second input end of the amplifier, and a control end coupled to an output end of the amplifier; and
a second resistor having a first end coupled to the second end of the third transistor.

6. The multi-channel current driver as claimed in claim 5, wherein the amplifier is an operational amplifier.

7. The multi-channel current driver as claimed in claim 5, wherein the third transistor is an NMOS transistor.

8. The multi-channel current driver as claimed in claim 1, further comprising a current source coupled to the channels so as to provide the first reference current.

9. The multi-channel current driver as claimed in claim 1, further comprising:
a current source providing a second reference current; and
a current minor having a master current end coupled to the current source so as to receive the second reference current, and a slave current end coupled to the channels so as to provide the first reference current.

10. The multi-channel current driver as claimed in claim 9, wherein the current mirror comprises:
a fourth transistor having a first end serving as the master current end of the current mirror, a second end coupled to a first voltage, and a control end coupled to the first end of the fourth transistor; and
a fifth transistor having a first end serving as the slave current end of the current mirror, a second end coupled to the first voltage, and a control end coupled to the control end of the fourth transistor.

11. The multi-channel current driver as claimed in claim 10, wherein the fourth transistor and the fifth transistor are P-channel metal oxide semiconductor (PMOS) transistors.
